(19) United States
(12) Patent Application Publication
(10) Pub. No.: US 2025/0382709 A1
(43) Pub. Date: Dec. 18, 2025

(54) Multi-Port Inlet Interdigitated Flow Field with Cross-Feed Cooling Loop for Proton Exchange Membrane Water Electrolyzers

(71) Applicants: Derek Lubie, Miami Beach, FL (US); Carel Minnaar, Helderkruin (ZA)

(72) Inventors: Derek Lubie, Miami Beach, FL (US); Carel Minnaar, Helderkruin (ZA)

(21) Appl. No.: 18/740,834

(22) Filed: Jun. 12, 2024

(51) Int. Cl. C25B 1/04; C25B 9/23; C25B 9/77; C25B 11/081; C25B 15/021; C25B 15/027; C25B 15/08

(52) U.S. Cl. CPC C25B 1/04; C25B 9/23; C25B 9/77; C25B 11/081; C25B 15/021; C25B 15/027; C25B 15/08

(57) ABSTRACT

The present invention discloses a novel multi-port inlet interdigitated flow field design with a cross-feed cooling loop for Proton Exchange Membrane Water Electrolyzers (PEMWEs). The flow field design comprises multiple inlet ports converging at the rear of the bipolar plate, leading to holes that allow reactant entry into the interdigitated flow field for uniform distribution. The cross-feed cooling loop, integrated with a flow reversal mechanism, circulates coolant in a cross-flow direction relative to the reactant flow, minimizing temperature gradients. The invention further includes an O-ring and channels at the back of the bipolar plate, facilitating the implementation of multiple parallel-feed ports for even pressure and flow at the inlet of each anode cell. This design enhances mass transport, improves reactant distribution, and provides efficient thermal management in PEMWEs.

### BACKGROUND

The present invention relates to the field of flow field designs for Proton Exchange Membrane Water Electrolyzers (PEMWEs). More specifically, the invention pertains to a multi-port inlet interdigitated flow field design with a cross-feed cooling loop for enhanced mass transport, improved reactant distribution, and efficient thermal management in PEMWEs.

Proton Exchange Membrane Water Electrolyzers (PEMWEs) have gained significant attention as a promising technology for hydrogen production due to their high efficiency, compact design, and ability to generate high-purity hydrogen. However, the performance and durability of PEMWEs are heavily influenced by the flow field design, which plays a crucial role in reactant distribution, mass transport, and thermal management.

Conventional flow field designs, such as parallel, serpentine, and interdigitated flow fields, have been widely used in PEMWEs. For instance, U.S. Pat. No. 8,097,385 discloses a bipolar plate assembly for fuel cells with a flow field layer made of porous carbon and a polymer-impregnated perimeter portion, exhibiting excellent heat transfer characteristics. U.S. patent application Ser. No. 20/040,023100 describes a flow field plate with gas delivery channels and narrow gas diffusion channels for efficient reactant distribution. Additionally, U.S. Pat. No. 6,638,657 presents separators for electrochemical cells with gas barriers and electrically conducting pathways to enhance performance and stability.

Despite these advancements, traditional flow field designs often face challenges in achieving uniform reactant distribution, efficient mass transport, and effective thermal management. Non-uniform distribution of reactants can lead to localized hotspots, reduced catalyst utilization, and decreased overall performance. Moreover, inadequate removal of product gases and inefficient heat dissipation can result in performance degradation and reduced durability of PEMWEs.

To address these limitations, researchers have explored various modifications to flow field designs. For example, studies have investigated the effects of interdigitated flow fields on multi-phase flow and oxygen concentration distribution in fuel cells. It has been found that interdigitated flow fields can yield higher and more uniform oxygen concentration and lower liquid saturation at the catalyst layer compared to conventional designs.

Furthermore, the incorporation of multiple inlet ports and optimized channel geometries has shown promise in enhancing reactant distribution and mass transport. US Patent Application 20020037592 discloses a fuel cell collector plate with improved mass transfer channels, featuring outlet channels with larger cross-sectional areas than inlet channels for better reactant distribution. Similarly, US Patent Application 20020119358 describes a stamped bipolar plate with serpentine and interdigitated flow fields on opposite sides for improved performance.

Thermal management is another critical aspect of PEMWE performance and durability. Ineffective heat dissipation can lead to temperature gradients, membrane dehydration, and reduced efficiency. Researchers have investigated the effects of various flow field designs on thermal management in fuel cell stacks. The study highlighted the importance of optimizing flow field designs to achieve uniform temperature distribution and efficient heat removal.

Despite these efforts, there remains a need for a flow field design that combines the benefits of multi-port inlet interdigitated flow fields with efficient thermal management. The present invention addresses this need by introducing a novel flow field design that incorporates multiple inlet ports, interdigitated flow fields, and a cross-feed cooling loop. This design aims to enhance reactant distribution, improve mass transport, and provide effective thermal management in PEMWEs.

The multi-port inlet interdigitated flow field design of the present invention allows for uniform distribution of reactants across the active area of the PEMWE. By incorporating multiple inlet ports, the design reduces pressure drops and ensures consistent reactant supply to the catalyst layer. The interdigitated flow fields promote forced convection and enhance mass transport, facilitating the removal of product gases and preventing localized flooding.

Moreover, the cross-feed cooling loop integrated into the design enables efficient heat removal and temperature regulation. By circulating a coolant, using two separate cooling loops, in a cross-flow direction relative to each other and the reactant flow, the cooling loop minimizes temperature gradients and maintains optimal operating conditions. The flow reversal mechanism further enhances thermal management by periodically reversing the coolant flow direction, promoting uniform heat distribution.

In summary, the present invention introduces a multi-port inlet interdigitated flow field design with a cross-feed cooling loop for PEMWEs. By leveraging the benefits of multiple inlet ports, interdigitated flow fields, and efficient thermal management, this invention aims to overcome the challenges associated with reactant distribution, mass transport, and heat dissipation in PEMWEs. The novel design holds great promise for advancing the field of hydrogen production and contributing to the development of sustainable energy technologies.

### SUMMARY

The present invention relates to a novel multi-port inlet interdigitated flow field design with a cross-feed cooling loop for Proton Exchange Membrane Water Electrolyzers (PEMWEs). The invention aims to enhance mass transport, improve reactant distribution, and provide efficient thermal management in PEMWEs.

The flow field design incorporates multiple inlet ports that converge at the rear of the bipolar plate, leading to several holes that allow the reactant to enter the interdigitated flow field and flow in-plane. This configuration ensures uniform distribution of reactants across the active area of the PEMWE, reducing pressure drops and promoting consistent reactant supply to the catalyst layer. The interdigitated flow fields facilitate forced convection and enhance mass transport, enabling effective removal of product gases and preventing localized flooding.

To address the issue of temperature gradients resulting from a single cooling loop, the invention introduces a cross-feed cooling loop integrated into the design. The cooling loop circulates a coolant, using two separate cooling loops, in a cross-flow direction relative to each other and the reactant flow, minimizing temperature gradients and maintaining optimal operating conditions. A flow reversal mechanism is employed to periodically reverse the coolant flow direction, promoting uniform heat distribution and efficient thermal management.

The multi-port inlet interdigitated flow field design also features an O-ring and channels cut at the back of the bipolar plate. These elements enable the implementation of the multiple parallel-feed ports, which converge at the rear of the plate and facilitate the ingress of coolant or reactant (water) to the cell from the rear. This design ensures even pressure and flow at the inlet of each anode cell and enables uniform distribution and transportation of the reactant through channels and porous layers to reach the membrane's catalytic area.

By leveraging the benefits of multiple inlet ports, interdigitated flow fields, and efficient thermal management, the present invention overcomes the challenges associated with reactant distribution, mass transport, and heat dissipation in PEMWEs. The novel design enhances the overall performance and durability of PEMWEs, contributing to the advancement of hydrogen production and sustainable energy technologies.

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a diagram that illustrates a back-side of an anode bipolar plate where multiple inlet ports distribute the reactant (water) flow to better reach the interdigitated flow fields on the other side, in accordance with an embodiment of the present invention.

FIG. 2 is a diagram that illustrates a front side of an anode bipolar plate where a porous transport layer is installed together with the catalyst coated membrane, in accordance with an embodiment of the present invention.

FIG. 3 is a diagram that illustrates how the anode bipolar plate looks like from the front and back, in accordance with an embodiment of the present invention.

FIG. 4 is a diagram that illustrates a back-side of a cathode bipolar plate with a recess where multiple inlet ports distribute the reactant (water) flow to better reach the interdigitated flow fields in-plane at the anode, in accordance with an embodiment of the present invention.

FIG. 5 is a diagram that illustrates a front-side of a cathode bipolar plate where a pressure-balancing grid and multiple outlet ports distribute the reactant (water) and gas flow to exit the cell on the other side, in accordance with an embodiment of the present invention.

FIG. 6 is a diagram that illustrates how a cathode bipolar plate looks like from the front and back, in accordance with an embodiment of the present invention.

FIG. 7 is a diagram that illustrates how an anode and cathode bipolar plate can be stacked together in a back-to-back configuration as viewed from the anode side, in accordance with an embodiment of the present invention.

FIG. 8 is a diagram that illustrates how an anode and cathode bipolar plate can be stacked together in a back-to-back configuration as viewed from the cathode side, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

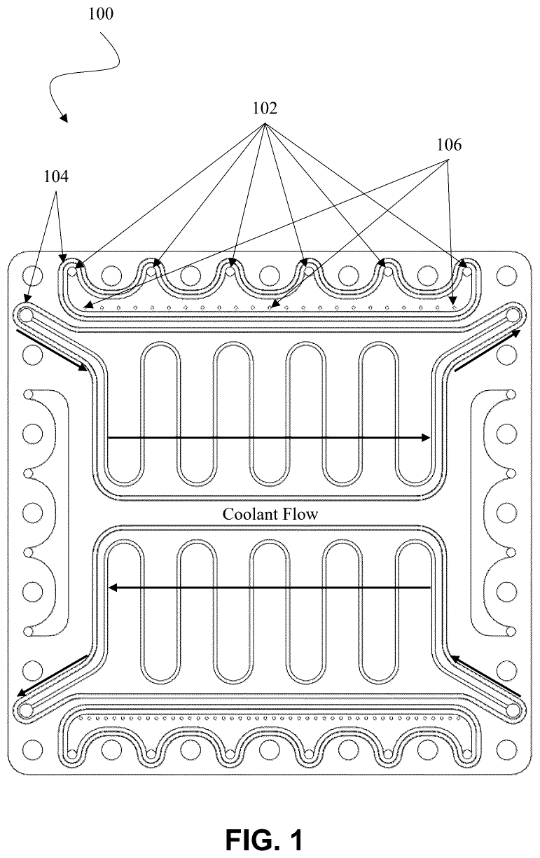

FIG. 1 is a diagram 100 that illustrates the back-side of an anode bipolar plate where multiple inlet ports distribute the reactant (water) flow to better reach the interdigitated flow fields on the other side, in accordance with an embodiment of the present invention. The diagram 100 illustrates the back side of the bipolar plate, showcasing the arrangement of multiple inlet ports, O-rings, and channel feed distribution for the reactant (water) flow. This design aims to enhance the distribution of the reactant to effectively reach the interdigitated flow fields located on the opposite side of the bipolar plate. In the diagram 100, the multiple inlet ports, denoted as 102, are strategically positioned on the back side of the bipolar plate. These ports serve as entry points for the reactant (water) flow into the plate. By having multiple inlet ports, the design ensures improved distribution of the reactant across the plate's surface, facilitating even and efficient flow distribution to the interdigitated flow fields. To maintain proper sealing and prevent leakage, O-rings 104 are employed at the interface between the bipolar plate and the reactant inlet ports. These O-rings create a tight and secure seal, preventing any potential leaks that could compromise the performance and functionality of the electrolyzer system. The diagram 100 also features channel feed distribution 106, which refers to the arrangement of channels that direct the reactant flow from the inlet ports towards the interdigitated flow fields. These channels configured in a serpentine manner play a crucial role in ensuring the proper distribution and transportation of the reactant to the desired locations within the electrolyzer stack. Additionally, the diagram 100 provides an arrow indicating the direction of coolant flow. This arrow represents the flow direction of the coolant used for the crossflow cooling loop. The crossflow cooling loop is an integral part of the system design, responsible for effectively dissipating heat from the stack. It operates by circulating coolant in a specific direction to remove excess heat generated during the operation of the stack. Moreover, the diagram 100 suggests that the flow direction of the coolant can be reversed if necessary. By incorporating smart solenoid switches into the system's Piping and Instrumentation Diagram (P&ID), the flow direction of the coolant can be adjusted as per the system's requirements. This flexibility allows for efficient control and optimization of the cooling process within the system. Overall, the diagram 100 provides a visual representation of the back side of the bipolar plate, highlighting the multiple inlet ports, O-rings, channel feed distribution, and the flow direction of the coolant. These elements collectively contribute to the efficient operation and thermal management of the electrolyzer system.

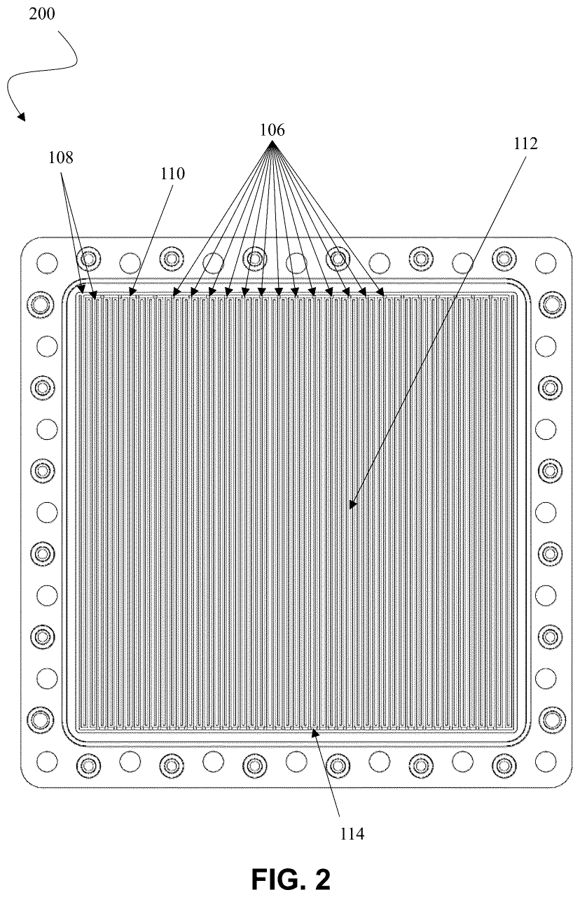

FIG. 2 is a diagram 200 that illustrates the front side of an anode bipolar plate where a porous transport layer is installed together with the catalyst coated membrane, in accordance with an embodiment of the present invention. It describes the details of the front side of the anode bipolar plate, specifically focusing on the installation of the porous transport layer and catalyst-coated membrane at the anode side. The diagram labeled as “200” represents this front side configuration, highlighting various components and their functions.

Landing Area (108): The landing area refers to the region on the front side of the bipolar plate which serves as a barrier by separating the inlet channels where the reactant (water) enters from the exiting channels where the remaining reactant and product gasses will exit. This area acts as a “landing pad” for the PTLs to rest on, facilitating both electrical contact and separation between the reactant inlet and its distribution to the subsequent channels. This forces the reactant through the PTLs in-plane within the recess area, removing any product gasses trapped within its structure allowing uniform cooling and current density distribution. To further elaborate, the landing area refers to the region where material is intentionally left during the CNC cutting process. It is important to note that no channels are present in this specific area. In an interdigitated design, two separate flow fields are integrated into a single structure, while remaining physically distinct from each other. This configuration results in the filling of the inlet channels or grooves with water until they reach their maximum capacity. Once the channels are filled, the excess water is then forced through the porous layer, traversing in a through-plane direction. This flow pattern helps to remove any trapped gases that may be present within the system. By effectively sweeping out these gases, the availability of reactants to the active catalytic sites is improved. Consequently, this leads to a more uniform distribution of current density throughout the system, optimizing the overall performance of the electrolyzer. The interdigitated design incorporates distinct flow fields and utilizes the landing area to ensure proper filling of the inlet channels. The subsequent forced flow through the porous layer removes trapped gases, enhancing the availability of reactants to the active catalytic sites. This design approach promotes a more uniform distribution of current density, resulting in improved overall performance of the electrolyzer.

In some embodiments, the porous transport layer and catalyst-coated membrane may be composed of specific materials to optimize performance. The porous transport layer can be made from materials such as sintered titanium powder, carbon cloth, carbon paper, or graphite felt. These materials provide excellent electrical conductivity, high surface area, and good mechanical stability, making them suitable for efficient reactant distribution and gas removal. The catalyst-coated membrane may feature an anode catalyst layer composed of iridium, ruthenium, or platinum, and a cathode catalyst layer made of platinum, palladium, or nickel. These catalyst materials are known for their high catalytic activity and stability in electrolyzer applications, enhancing the efficiency of the electrochemical reactions.

In another embodiment of the present invention, the flow field design comprises a plurality of interdigitated flow fields with specific dimensions for the inlet channels and exiting channels. The inlet channels 110 and exiting channels 114 of the plurality of interdigitated flow fields 112 have a width in a range of 0.5 mm to 2 mm and a depth in a range of 0.5 mm to 2 mm. These dimensions are carefully selected to optimize the reactant flow distribution, gas removal, and overall performance of the electrolyzer stack. The width range of 0.5 mm to 2 mm ensures that the channels are sufficiently wide to allow for efficient reactant flow while maintaining a compact design. Similarly, the depth range of 0.5 mm to 2 mm provides adequate space for reactant transport and gas removal while minimizing the overall thickness of the bipolar plate. By employing these specific dimensions for the inlet and exiting channels, the flow field design achieves a balance between reactant distribution, gas removal, and structural integrity of the bipolar plate.

In yet a further embodiment, the flow field design incorporates a landing area 108 with a specific width range. The landing area 108, which is disposed on the front side of the bipolar plate and separates the plurality of inlet channels 110 from the plurality of exiting channels 114, has a width in a range of 0.5 mm to 5 mm. This width range is carefully chosen to provide an optimal balance between reactant flow distribution and structural support for the porous transport layer and catalyst-coated membrane. A landing area 108 width of 0.5 mm to 5 mm ensures sufficient separation between the inlet channels 110 and exiting channels 114, ensuring efficient gas removal within the porous layer. Additionally, this width range provides adequate surface area for the porous transport layer and catalyst-coated membrane to be securely supported, ensuring proper electrical contact and minimizing the risk of deformation or damage during operation. By incorporating a landing area 108 with a width in the range of 0.5 mm to 5 mm, the flow field design enhances the overall performance, durability, and reliability of the electrolyzer stack.

Inlet Channel (110): The inlet channel is the pathway through which the reactant enters the front side of the bipolar plate. The multiple ports mentioned earlier in the description “feed” the inlet channel, allowing the reactant to “fill” the channels effectively.

Distribution (106): The distribution component ensures the proper distribution of the reactant within the channels. It helps evenly distribute the reactant to all interdigitated flow fields (denoted as “Interdigitated FF” 112) on the front side of the bipolar plate.

Interdigitated Flow Fields (112): The interdigitated flow fields are the channels or pathways on the front side of the bipolar plate that are responsible for transporting the reactant and facilitating the removal of oxygen gas. The multiple ports ensure that the reactant flows through the porous transport layer and forces the reactant through this layer, effectively removing oxygen gas in the process.

Exiting Channel (114): The exiting channel is the pathway through which the gases or byproducts (oxygen) resulting from the reaction are transported away from the interdigitated flow fields. It helps ensure the efficient removal of gases from the electrolyzer stack.

The implementation method of this design distinguishes it from others by enabling the use of multiple inlet ports and their careful distribution to ensure that the reactant follows a more uniform and balanced path while still supporting the porous transport layer. This design takes into consideration the higher operating pressure in an electrolyzer compared to a fuel cell. By allowing for higher pressure, this design can accommodate the specific requirements of electrolyzers, optimizing their performance.

The diagram 200 explains the details of the front side of the bipolar plate, focusing on the installation of the porous transport layer and catalyst-coated membrane. The figure illustrates this front side configuration, highlighting key components and their functions. The porous transport layer is a critical element in electrolyzer systems. It facilitates the transport of reactants and promotes efficient electrochemical reactions. The catalyst-coated membrane, which is typically positioned between the PTLs, enhances the reaction efficiency by providing a catalytic surface. The multiple ports serve the purpose of supplying the reactant (water) to the inlet channel. These ports ensure that the reactant is distributed evenly and fills all the Flow Fields on the front side of the bipolar plate. This distribution is important to ensure that there are no channels with a longer path, which would result in higher resistance to flow.

By having multiple ports with better distribution, the design enables improved reactant transportation, gas removal, and cooling efficiency within the electrolyzer system. Once the reactant enters the channels, it is “forced” through the porous transport layer. This action helps to remove oxygen or any other gases that may be present in the system. The reactant then flows into the adjacent channel, referred to as “channel 2” 114 in FIG. 2, which is responsible for transporting the gases away from the interdigitated flow fields. The use of multiple ports and their careful distribution ensures that the reactant follows a more uniform and balanced path, minimizing any variations in flow resistance. This leads to enhanced reactant transportation, efficient gas removal, and improved cooling performance within the electrolyzer. The method of implementation distinguishes this design from others by allowing for higher pressure while still effectively supporting the porous transport layer. In fuel cells, the feeding area (inlet channel) is often wider to accommodate the lower operating pressure typically associated with fuel cell systems. However, in an electrolyzer, the pressure levels are significantly higher, necessitating a different approach.

This design considers the higher-pressure requirements of electrolyzers and ensures compatibility with the porous transport layer while maintaining efficient reactant distribution and gas removal. In summary, the described design for the front side of the bipolar plate, along with its method of implementation, enables effective reactant distribution, gas removal, and cooling in the electrolyzer systems. The multiple ports, combined with a uniform channel path, enhances reactant transportation, optimizes gas removal, and accommodates differential pressure requirements in different types of systems.

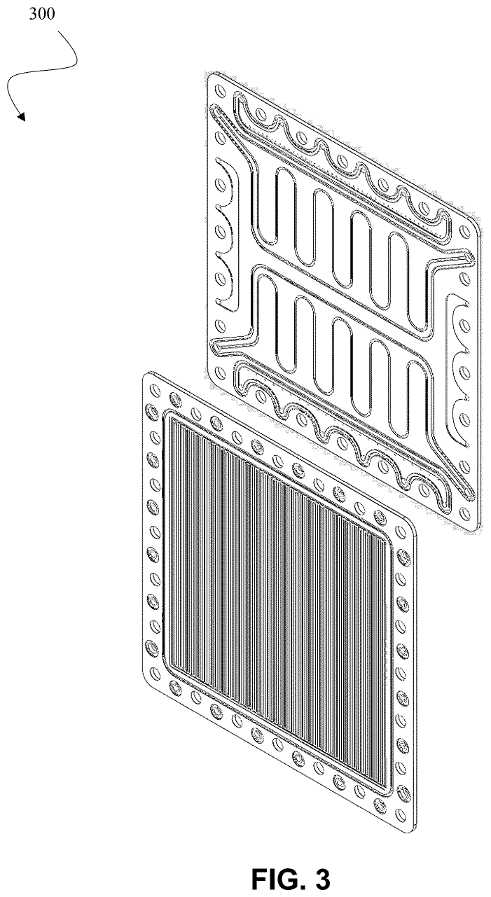

FIG. 3 is a diagram 300 that illustrates how the anode bipolar plate looks like from the front and back, in accordance with an embodiment of the present invention. The bipolar plate is a key component in the electrolyzer systems, serving as a separator and a conduit for reactant flow. It typically consists of two sides, a front side, and a back side. The front side of the bipolar plate is where the reactant enters the system and interacts with the catalyst-coated membrane and the porous transport layer. This side is responsible for distributing the reactant and facilitating the electrochemical reactions. The back side of the anode bipolar plate is typically designed to optimize cooling and heat dissipation and is stacked together with the back side of the cathode bipolar plate. It may feature various cooling channels or other structures to help regulate the temperature within the system.

When it comes to stacking multiple bipolar plates together, they are usually aligned in a way that allows for the sequential flow of reactants through the electrolyzer system. The plates are placed one on top of the other, forming a stack configuration. This stacking arrangement allows for the efficient utilization of space and ensures a continuous flow path for the reactants and gases involved in the electrochemical processes.

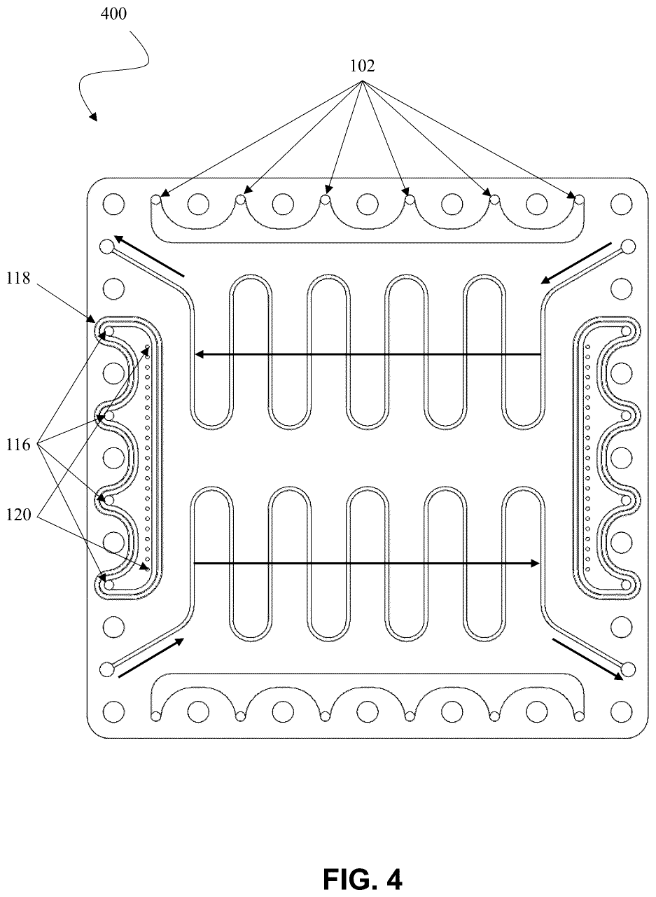

FIG. 4 is a diagram 400 that illustrates the back-side of a cathode bipolar plate where multiple outlet ports distribute the reactant (water) flow to better reach the pressure-balancing flow fields on the other side, in accordance with an embodiment of the present invention. The diagram 400 illustrates the back side of the cathode bipolar plate, showcasing the arrangement of multiple inlet ports, O-rings, and outlet transport for the reactant (water) and gas (hydrogen) flow. This design aims to enhance the distribution of the pressure in the cell so the reactant and gas effectively reaches the exiting ports located on the opposite side of the bipolar plate. In the diagram 400, the multiple outlet ports, denoted as 116, are strategically positioned on the back side of the bipolar plate. These ports serve as exiting points for the reactant (water) and gas (hydrogen) flow out of the plate.

By having multiple outlet ports, the design ensures improved distribution of pressure across the plate's surface, facilitating even and efficient flow distribution within the pressure-balancing flow fields. To maintain proper sealing and prevent leakage, O-rings (118) are employed at the interface between the bipolar plate and the reactant inlet ports. These O-rings create a tight and secure seal, preventing any potential leaks that could compromise the performance and functionality of the electrolyzer system. The diagram 400 also features channel exit distribution (120), which refers to the arrangement of through-plane holes that direct the reactant and gas flow from the pressure-balancing grid towards the exiting ports. These channels play a crucial role in ensuring the proper distribution and transportation of the reactant and gas to the desired locations within the electrolyzer stack.

Additionally, the diagram 400 provides an arrow indicating the direction of coolant flow as seen from the cathode side. This arrow represents the flow direction of the coolant used for the crossflow cooling loop when placed back-to-back with an anode bipolar plate. The diagram 400 suggests that the flow direction of the coolant can be reversed if necessary. Overall, the diagram 400 provides a visual representation of the back side of the bipolar plate, highlighting the multiple outlet ports, O-rings, channel feed distribution, and the flow direction of the coolant. These elements collectively contribute to the efficient operation, thermal management and pressure-distribution of the electrolyzer system.

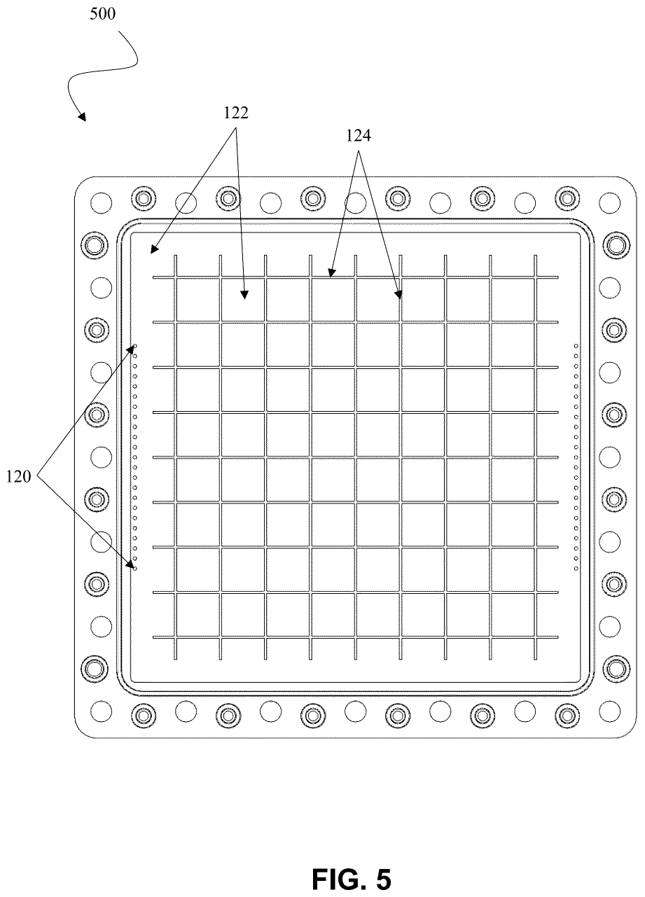

FIG. 5 is a diagram 500 that illustrates the front side of a cathode bipolar plate where a porous transport layer is installed together with the catalyst coated membrane, in accordance with an embodiment of the present invention. It describes the details of the front side of the cathode bipolar plate, specifically focusing on the installation of the porous transport layer and catalyst-coated membrane as installed on the cathode side. The diagram labeled as “500” represents this front side configuration, highlighting various components and their functions.

Landing Area (122): The landing area refers to the region on the front side of the bipolar plate which serves as a barrier between channels while also ensuring proper electrical contact with the PTL is maintained. This area acts as a “landing pad” for the PTLs to rest on, facilitating both electrical contact and separation between the reactant and gas outlet and its distribution towards the subsequent channels. The landing area refers to the region where material is intentionally left during the CNC cutting process. It is important to note that no channels are present in this specific area.

Exiting Channel (124): The exiting channels are the pathway through which the reactant and gas exits the front side of the cathode bipolar plate. The multiple ports mentioned earlier in the description “empties” the outlet channels.

Distribution (120): The distribution component ensures the proper distribution of the reactant and gas pressure within the cell by providing multiple pathways.

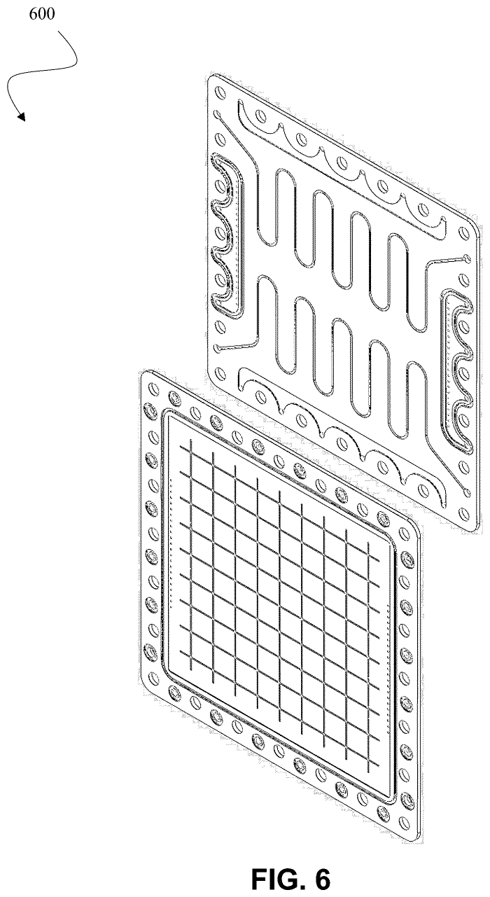

FIG. 6 is a diagram 600 that illustrates how the cathode bipolar plate looks like from the front and back, in accordance with an embodiment of the present invention. The diagram 600 illustrates the appearance of the cathode bipolar plate from both the front and back sides.

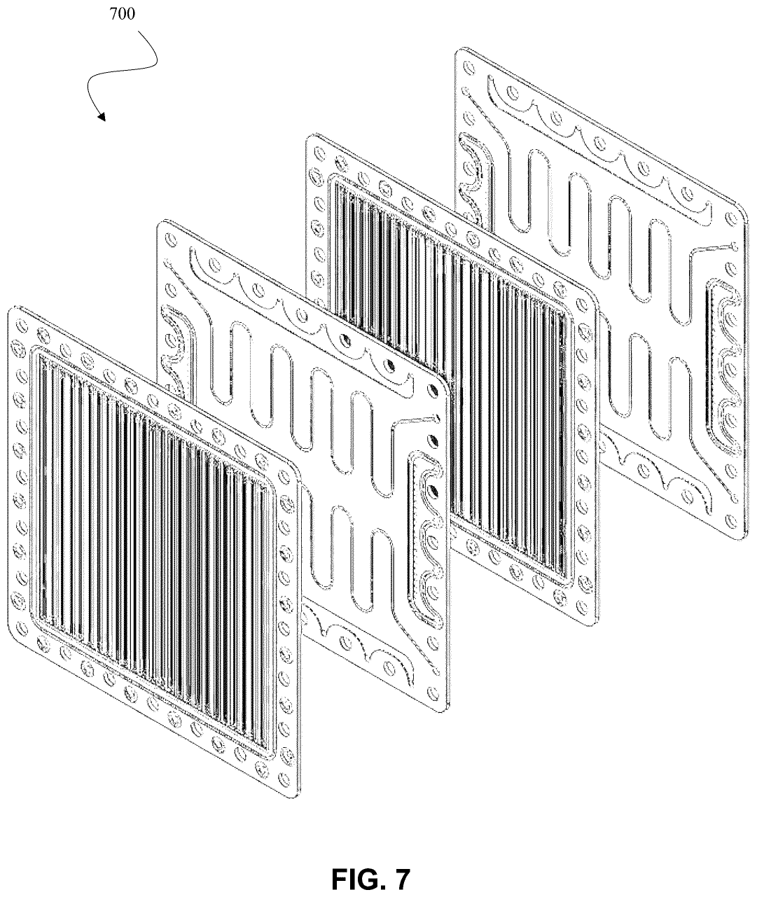

FIG. 7 is a diagram 700 that illustrates how the anode and cathode bipolar plates can be stacked together as viewed from the anode side facing the viewer and the back side of the anode facing the back side of the cathode to allow the bipolar plates to form a functional “cell”, in accordance with an embodiment of the present invention. The two cooling loops at the back side of the anode and cathode bipolar plates aligns with each other and allows the o-rings to seal the interface between the two plates. The diagram also shows the two front sides of each bipolar plate (anode & cathode) faces each other in the middle.

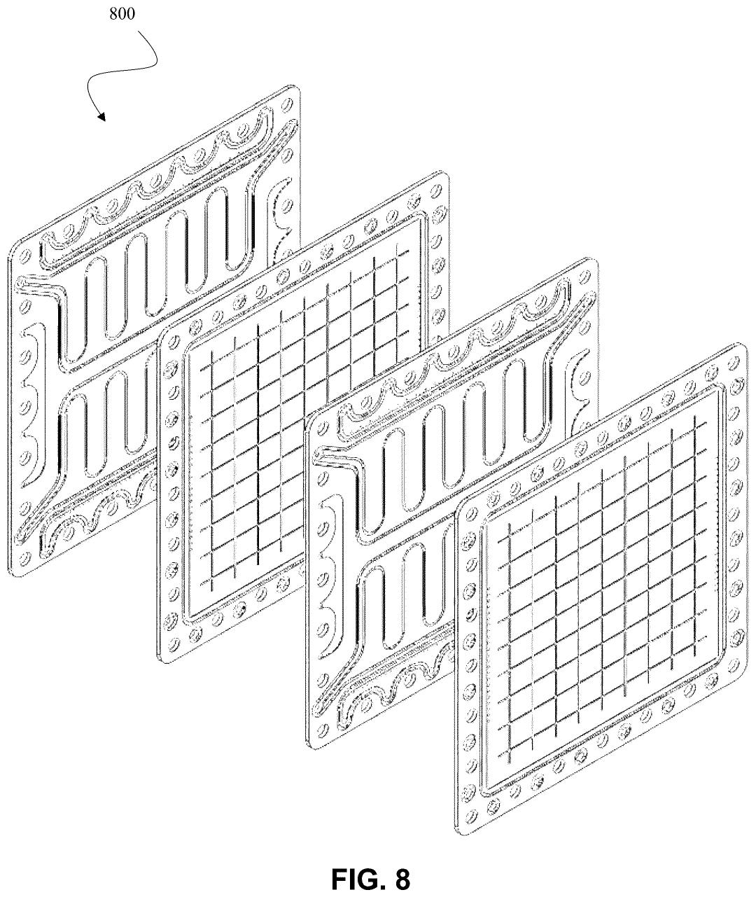

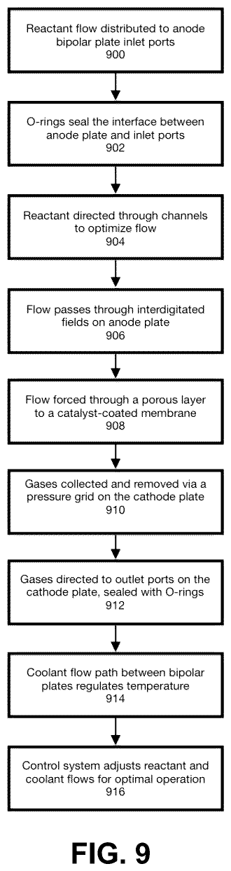

FIG. 8 is a diagram 800 that illustrates how the anode and cathode bipolar plates can be stacked together as viewed from the cathode side facing the viewer and the back side of the anode facing the back side of the cathode to allow the bipolar plates to form a functional “cell”, in accordance with an embodiment of the present invention. The two cooling loops at the back side of the anode and cathode bipolar plates aligns with each other and allows the o-rings to seal the interface between the two plates. The diagram also shows the two front sides of each bipolar plate (anode & cathode) faces each other in the middle.

FIG. 9 is a flow diagram illustrating the operation of the Proton Exchange Membrane Water Electrolyzer (PEMWE) according to the present invention. The process steps are denoted by reference numerals in the 900 series.

The process begins at step 900, where a reactant flow is distributed to a plurality of inlet ports 102 located on the back side of an anode bipolar plate. The inlet ports are evenly distributed to ensure uniform distribution of the reactant flow. One or more O-rings 104 are disposed at the interface between the anode bipolar plate and the inlet ports to provide sealing and prevent leakage step 902.

Next, at step 904, the reactant flow is directed from the inlet ports to a plurality of channels 106 formed on the back side of the anode bipolar plate. These channels have a gradually decreasing width from the inlet ports to a plurality of interdigitated flow fields 112 located on the front side of the anode bipolar plate, optimizing the reactant flow distribution.

The reactant flow is then transported through the interdigitated flow fields 112 (step 906), which comprise alternating inlet channels 110 and exiting channels 114. The inlet channels receive the reactant flow from a porous transport layer disposed on the front side of the anode bipolar plate, while the exiting channels transport gases out of the flow field design.

At step 908, the reactant flow is forced through the porous transport layer, which facilitates the removal of gases and distributes the reactant to a catalyst-coated membrane disposed on the porous transport layer. The catalyst-coated membrane comprises an anode catalyst layer on the side facing the anode bipolar plate.

The reactant and product gases are then collected and removed via a pressure-balancing grid located on the front side of a cathode bipolar plate (step 910). The cathode bipolar plate is aligned in a stacked configuration with the anode bipolar plate, with their back sides adjacent to each other, forming a coolant flow path between them.

Finally, at step 912, the reactant and product gases are directed to a plurality of outlet ports 116 located on the back side of the cathode bipolar plate. The outlet ports are positioned to align with the pressure-balancing grid for efficient removal of the gases. One or more O-rings 118 are disposed at the interface between the cathode bipolar plate and the outlet ports to provide sealing and prevent leakages.

Throughout the process, a coolant flow path formed between the back sides of the anode and cathode bipolar plates helps regulate the temperature of the PEMWE (step 914). The coolant flow path may have a serpentine configuration for enhanced heat transfer, and a temperature sensor may be disposed in the coolant flow path for monitoring and control purposes

A control system (step 916) is configured to adjust the flow rate and direction of the reactant flow and coolant flow based on operating conditions and performance parameters of the electrolyzer, ensuring optimal operation of the PEMWE.

In some embodiments, the electrolyzer system may incorporate additional features such as a temperature sensor and a control system to optimize performance and safety. A temperature sensor can be strategically placed in the coolant flow path to monitor and regulate the temperature of the electrolyzer stack. This sensor could be a thermocouple, resistance temperature detector (RTD), or thermistor, depending on the desired accuracy and response time. The sensor would be connected to a control system that processes the temperature data and adjusts the coolant flow rate or triggers safety measures if necessary. The control system, which could be a programmable logic controller (PLC) or a microcontroller-based unit, would also be configured to adjust the flow rate and direction of the reactant and coolant flows based on operating conditions and performance parameters. This can be achieved by integrating flow control valves, variable frequency drives for pumps, and smart solenoid switches into the system. The control system would receive inputs from various sensors (temperature, pressure, flow rate) and use algorithms to optimize the flow rates and directions in real-time. This integrated approach ensures that the electrolyzer operates within safe limits, maximizes efficiency, and adapts to changing operating conditions.

The anode bipolar plate includes multiple inlet ports 102 on the back side, with O-rings 104 at the interface between the bipolar plate and the reactant inlet ports. The channel feed distribution 106 arranges channels that direct reactant flow to the landing area 108 on the front side of the anode bipolar plate. The reactant enters the front side through the inlet channel 110 and flows through the interdigitated flow fields 112, which are pathways for transporting reactant and facilitating gas removal. The gases or by-products exit from the interdigitated flow fields through the exiting channel 114.

The cathode bipolar plate features multiple outlet ports 116 on the back side, with O-rings 118 at the interface between the bipolar plate and the reactant outlet ports. The channel exit distribution 120 arranges channels to direct reactant and gas flow from the landing area 122 on the front side of the cathode bipolar plate. The gases or by-products exit the front side through the exiting channel 124.

There are several potential applications and benefits of the proposed design, which combines multiple inlet ports, an interdigitated flow field, and a cross-feed cooling system. The design aims to address the limitations typically associated with interdigitated designs operating at higher current densities. By adopting this design, manufacturers of electrolyzer stacks can enhance the durability and performance of their commercially available electrolyzer stacks. The following are some of the diverse applications where this design can be implemented:

Chemicals: The design is relevant to produce chemicals such as methanol and ammonia, which currently account for approximately 50% of global hydrogen use. The shipping industry, for instance, supports the use of ammonia derived from green hydrogen to reduce emissions.

Power Plants: The design is suitable for hydrogen-cooled power plants, particularly those with a capacity of over 100MW. Hydrogen is used as a coolant in these plants to maintain optimal operating temperatures.

Heat Treating: The design finds application in metallurgical processes like sintering, brazing, annealing, powder coating, metal injection molding, and welding operations. Efficient heat dissipation and temperature control are essential in these processes.

Semiconductor Industry: The design is beneficial for the semiconductor industry, particularly in applications such as display manufacturing, LED production, and photovoltaic processes. Precise temperature control and efficient cooling are vital for these high-tech manufacturing processes.

Food Industry: The design can be employed in the food industry for hydrogenation processes, such as the hydrogenation of oils for margarine production.

Laboratories: The design enables on-site hydrogen production for gas chromatography and various research applications in laboratory settings.

Government & Advanced Life Support Systems: The design is relevant to advanced life support systems, including submarines, the International

Space Station, and the aerospace industry, where on-site oxygen generation is required.

Hydrogen Refueling Stations: The design can be applied in hydrogen refueling stations to support the transportation sector's transition to hydrogen-powered vehicles.

Float Glass Manufacturing: The design finds utility in float glass manufacturing processes, particularly in inertization applications.

Backup Power: The design can be used for off-grid electricity generation, grid stabilization, and energy storage from renewable energy sources.

By implementing this design in the aforementioned applications, the drawbacks associated with interdigitated designs operating at higher current densities can be mitigated. This can result in enhanced system durability, improved performance, and increased efficiency in various industrial and technological sectors.

Advantages of incorporating multiple inlet ports and a double cooling loop with a cross-feed in the design of an electrolyzer stack:

Multiple Inlet Ports: By incorporating multiple inlet ports, reactant entry into the stack can occur at various locations. This design eliminates the risk of pressure drops that may arise from corner feeding, where reactants are fed into the stack from a single corner. The multiple inlet ports ensure even distribution of the water feed across all the channels, resulting in a more uniform current and temperature density distribution. This uniform distribution prevents localized hotspots and ensures the Catalyst Coated Membrane (CCM) in each cell can withstand extended periods of use without experiencing significant stress or degradation.

Double Cooling Loop with Cross-Feed: The double cooling loop design involves the implementation of two separate cooling loops within the electrolyzer stack. The cross-feed configuration ensures that the cooling fluid is evenly distributed throughout the stack, providing efficient cooling to all cells.

This enhanced cooling is critical for maintaining optimal performance by preventing overheating and thermal degradation. The additional layer of cooling provided by the double cooling loop complements the cooling effect provided by the reactant flow, resulting in better heat dissipation and improved temperature regulation.

By utilizing multiple inlet ports and a double cooling loop with cross-feed, the design enhances reactant distribution and cooling within the electrolyzer stack. This, in turn, translates into several benefits:

Improved Reactant Distribution: The even distribution of the reactant across all channels ensures uniform current and temperature density distribution. This leads to improved performance, reduced localized hotspots, and enhanced durability of the Catalyst Coated Membrane (CCM) in each cell.

Enhanced Cooling: The double cooling loop with cross-feed design provides efficient cooling throughout the stack, preventing overheating and thermal degradation. This contributes to maintaining optimal performance and prolonging the service life of the electrolyzer stack.

Improved Performance and Prolonged Service Life: The combination of improved reactant distribution and enhanced cooling results in improved overall performance and prolonged service life of the electrolyzer stack. The stack can operate more efficiently, with reduced stress and better temperature regulation, leading to increased system reliability and longevity.

Thus, the incorporation of multiple inlet ports, a pressure-balancing grid flow field and a double cooling loop with a cross-feed design offers significant advantages in terms of reactant distribution and cooling in an electrolyzer stack. These design features contribute to improved performance, extended durability, and enhanced overall efficiency of the stack, ensuring optimal operation and prolonged service life.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A flow field design for a Proton Exchange Membrane Water Electrolyzer (PEMWE), comprising:
a bipolar plate having a front side and a back side, the back side comprising:
a plurality of inlet ports for distributing a reactant flow;
one or more O-rings disposed at an interface between the bipolar plate and the plurality of inlet ports for sealing and preventing leakage;
a plurality of channels for directing the reactant flow from the plurality of inlet ports; and
the front side comprising:
a porous transport layer disposed on the front side of the bipolar plate;
a catalyst-coated membrane disposed on the porous transport layer;
a landing area disposed on the front side of the bipolar plate, the landing area separating a plurality of inlet channels from a plurality of exiting channels and providing a barrier between the reactant flow entering the inlet channels and flow exiting the exiting channels;
a plurality of interdigitated flow fields formed on the front side of the anode bipolar plate for transporting the reactant and facilitating removal of gases;
wherein the plurality of inlet ports enable distribution of the reactant flow to the plurality of interdigitated flow fields, and the reactant flow is forced through the porous transport layer to remove gases and distribute the reactant to the catalyst-coated membrane.

2. The flow field design of claim 1, wherein the plurality of inlet ports are evenly distributed across the back side of the bipolar plate to enable uniform distribution of the reactant flow to the plurality of interdigitated flow fields.

3. The flow field design of claim 1, wherein the plurality of channels on the back side of the bipolar plate have a gradually decreasing width from the plurality of inlet ports to the plurality of interdigitated flow fields to optimize reactant flow distribution.

4. The flow field design of claim 1, wherein the plurality of interdigitated flow fields comprise alternating inlet channels and exiting channels, the inlet channels receiving the reactant flow from the porous transport layer and the exiting channels transporting gases out of the flow field design.

5. The flow field design of claim 4, wherein the inlet channels and exiting channels of the plurality of interdigitated flow fields have a width in a range of 0.5 mm to 2 mm and a depth in a range of 0.5 mm to 2 mm.

6. The flow field design of claim 1, wherein the landing area has a width in a range of 0.5 mm to 5 mm.

7. The flow field design of claim 1, wherein the porous transport layer comprises a material selected from the group comprising: sintered powder, sintered fiber, sintered foam, woven mesh, and expanded metal.

8. The flow field design of claim 1, wherein the catalyst-coated membrane comprises a proton exchange membrane having an anode catalyst layer on a first side and a cathode catalyst layer on a second side opposite the first side.

9. The flow field design of claim 1, further comprising a coolant flow path formed on the back side of the bipolar plate, the coolant flow path configured to circulate a coolant in a cross-flow direction relative to the reactant flow in the plurality of interdigitated flow fields.

10. A Proton Exchange Membrane Water Electrolyzer (PEMWE) comprising:
an anode bipolar plate having a front side and a back side;
a cathode bipolar plate having a front side and a back side;
the back side of the anode bipolar plate comprising:
a plurality of inlet ports for distributing a reactant flow;
one or more O-rings disposed at an interface between the anode bipolar plate and the plurality of inlet ports for sealing and preventing leakage;
a plurality of channels for directing the reactant flow from the plurality of inlet ports;
the front side of the anode bipolar plate comprising:
a plurality of interdigitated flow fields for transporting the reactant and facilitating removal of gases;
a porous transport layer disposed on the plurality of interdigitated flow fields;
a catalyst-coated membrane disposed on the porous transport layer;
the back side of the cathode bipolar plate comprising:
a plurality of outlet ports for distributing the reactant flow and product gases;
one or more O-rings disposed at an interface between the cathode bipolar plate and the plurality of outlet ports for sealing and preventing leakage;
a plurality of channels for directing the reactant and gas flow to the plurality of outlet ports;
the front side of the cathode bipolar plate comprising:
a pressure-balancing grid for distributing pressure across the front side of the cathode bipolar plate;
wherein the anode bipolar plate and the cathode bipolar plate are aligned in a stacked configuration with the back side of the anode bipolar plate adjacent to the back side of the cathode bipolar plate forming a coolant flow path between the anode and cathode bipolar plates, and
wherein the reactant flow is distributed via the plurality of inlet ports of the anode bipolar plate to the plurality of interdigitated flow fields, forced through the porous transport layer to the catalyst-coated membrane, and the reactant and product gases are collected and removed via the pressure-balancing grid and plurality of outlet ports of the cathode bipolar plate.

11. The Proton Exchange Membrane Water Electrolyzer of claim 10, wherein the plurality of inlet ports are evenly distributed across the back side of the anode bipolar plate to provide uniform distribution of the reactant flow.

12. The Proton Exchange Membrane Water Electrolyzer of claim 10, wherein the plurality of channels on the back side of the anode bipolar plate have a serpentine configuration for enhanced distribution of the reactant flow from the inlet ports to the interdigitated flow fields.

13. The Proton Exchange Membrane Water Electrolyzer of claim 10, wherein the porous transport layer disposed on the front side of the anode bipolar plate comprises a material selected from the group comprising: titanium, carbon cloth, carbon paper, and graphite felt.

14. The Proton Exchange Membrane Water Electrolyzer of claim 10, wherein the catalyst-coated membrane disposed on the porous transport layer of the anode bipolar plate comprises an anode catalyst selected from the group comprising: iridium, ruthenium, and platinum.

15. The Proton Exchange Membrane Water Electrolyzer of claim 10, wherein the plurality of outlet ports on the back side of the cathode bipolar plate are positioned to align with the pressure-balancing grid on the front side of the cathode bipolar plate for efficient removal of reactant and product gases.

16. The Proton Exchange Membrane Water Electrolyzer of claim 10, wherein the pressure-balancing grid on the front side of the cathode bipolar plate comprises a plurality of through-holes for distributing pressure and facilitating transport of reactant and product gases to the outlet ports.

17. The Proton Exchange Membrane Water Electrolyzer of claim 10, further comprising a catalyst-coated membrane disposed on the front side of the cathode bipolar plate, wherein the catalyst-coated membrane comprises a cathode catalyst selected from the group comprising: platinum, palladium, and nickel.

18. The Proton Exchange Membrane Water Electrolyzer of claim 10, wherein the coolant flow path formed between the back sides of the anode and cathode bipolar plates comprises a serpentine configuration for enhanced heat transfer and temperature regulation.

19. The Proton Exchange Membrane Water Electrolyzer of claim 10, further comprising a temperature sensor disposed in the coolant flow path for monitoring and controlling the temperature of the electrolyzer stack.

20. The Proton Exchange Membrane Water Electrolyzer of claim 10, further comprising a control system configured to adjust the flow rate and direction of the reactant flow and coolant flow based on operating conditions and performance parameters of the electrolyzer.
